(19) United States
(12) Patent Application Publication
(10) Pub. No.: US 2018/0182266 A1
(43) Pub. Date: Jun. 28, 2018

(54) LIQUIFORM CHANNEL LETTER

(71) Applicant: Seoul Laser Dieboard System Co., Ltd., Lake Forest, CA (US)

(72) Inventor: Kyong Chan LIM, Lake Forest, CA (US)

(21) Appl. No.: 15/851,446

(22) Filed: Dec. 21, 2017

Related U.S. Application Data
(60) Provisional application No. 62/438,349, filed on Dec. 22, 2016.

(51) Int. Cl. G09F 13/04; B29C 39/10

(52) U.S. Cl. CPC G09F 13/0409; B29K 2105/0061; G09F 13/0404; B29C 39/10

(57) ABSTRACT

Methods and apparatus for substantially reducing dark spots on a front surface of a channel letter, including: forming a channel letter using a profile with at least one rib, the profile having a top and a bottom; coupling a face plate to the at least one rib; and filling a space between the face plate and the top of the profile with a resin material.

### CROSS-REFERENCE TO RELATED APPLICATIONS

This application claims the benefit of priority under 35 U.S.C. § 119(e) of co-pending U.S. Provisional Patent Application No. 62/438,349, filed Dec. 22, 2016, entitled “Liquiform Channel Letter.” The disclosure of the above-referenced application is incorporated herein by reference.

### BACKGROUND

### Technological Field

The present disclosure relates to channel letters, and more specifically, to liquiform channel letters.

### Background

Channel letters can be formed with rules and profiles having one or more ribs. The ribs can provide a surface onto which a face plate or bottom plate can be secured when completing the channel letter. In some cases, a top surface of the face plate is flush with top edges of the profile. This may provide certain aesthetic advantages because there is no further bending or forming required of the face plate to flange or wrap it over the top edges.

### SUMMARY

This disclosure describes methods and apparatus for substantially reducing dark spots on a front surface of a channel letter.

In one implementation, a method for substantially reducing dark spots on a front surface of a channel letter is disclosed. The method includes: forming a channel letter using a profile with at least one rib, the profile having a top and a bottom; coupling a face plate to the at least one rib; and filling a space between the face plate and the top of the profile with a resin material.

In another implementation, a channel letter formed using a profile including at least one rib is disclosed. The channel letter includes: a face plate coupled to a first rib of the at least one rib; and a layer of resin material disposed between the face plate and a top of the profile.

Other features and advantages of the present disclosure should be apparent from the following description which illustrates, by way of example, aspects of the disclosure.

### BRIEF DESCRIPTION OF THE DRAWINGS

The details of the present disclosure, both as to its structure and operation, may be gleaned in part by study of the accompanying drawings.

FIG. 1 is a perspective view of a portion of a profile.

FIG. 2 is a perspective view of another implementation of a profile.

FIG. 3 is a sectional view of a portion of an example channel letter.

FIG. 4 is a sectional view of a portion of another example channel letter.

FIG. 5 is a perspective view of a channel letter formed using a profile.

FIG. 6 is a front perspective view of the completed channel letter of FIG. 5 fitted with a face plate.

FIG. 7 is a sectional view of a portion of another example channel letter substantially similar to the channel letter shown in FIG. 3.

FIG. 8A is a sectional view of a portion of a channel letter in accordance with one implementation of the present disclosure.

FIG. 8B is a sectional view of a portion of a channel letter in accordance with another implementation of the present disclosure in which a face plate is attached to the top of the ribs prior to pouring the resin material.

FIG. 8C is a sectional view of a portion of a channel letter in accordance with another implementation of the present disclosure in which a face plate is attached to the inner surface of the profiles in lieu of the ribs after the shaping of the channel letter is completed.

FIG. 8D is a sectional view of a portion of a channel letter in accordance with another implementation of the present disclosure in which a face plate is put in place temporarily and removed after the resin material is poured in and hardened.

FIG. 9 is a functional flow diagram illustrating a method for substantially reducing dark spots on the front surface of the channel letter in accordance with one implementation of the present disclosure.

### DETAILED DESCRIPTION

Channel letters may include light emitting diodes (LEDs) disposed on the bottom plate to shine the light onto the face plate to illuminate the channel letter. However, the light from the LEDs may illuminate only a portion of the face plate and leave dark spots on the face plate, which is undesirable for channel letters. To address the issues associated with the dark spots on the face plate due to the LEDs illuminating only a portion of the face plate, some modifications can be made to the existing process for the formation of a channel letter.

The detailed description set forth below, in connection with the accompanying drawings, is intended as a description of various implementations and is not intended to represent the only implementations in which the disclosure may be practiced. The detailed description includes specific details for the purpose of providing a thorough understanding of the implementations. In some instances, well-known structures and components are shown in simplified form for brevity of description. As used herein, like reference numerals refer to like features throughout the written description.

As stated above, channel letters can be formed with metal rules and profiles having one or more ribs. The ribs can provide a surface onto which a face plate or bottom plate can be secured when completing the channel letter.

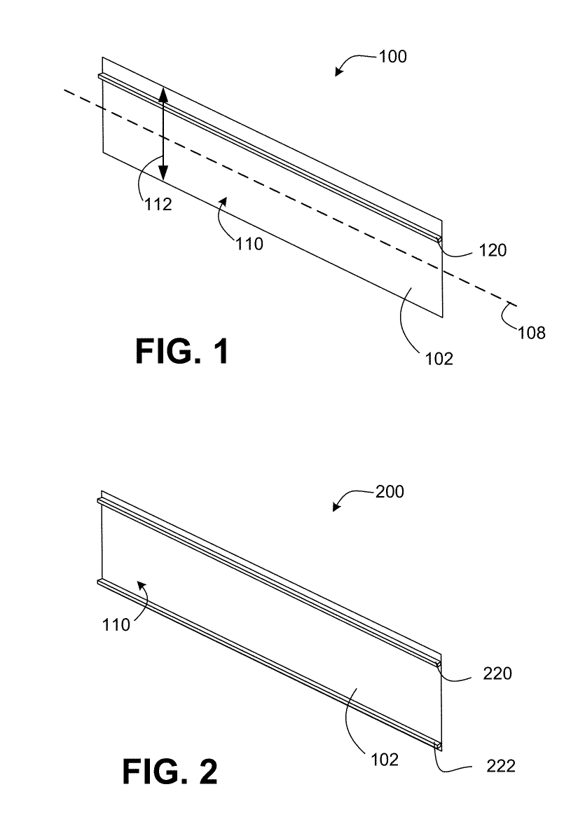

FIG. 1 is a perspective view of a portion of a profile. As shown in FIG. 1, the profile 100 can comprise a rule 102. As described herein, a “rule” may generally refer to a flat metallic strip. Additionally, a “profile” as used herein may generally refer to the rule 102 having at least one rib 120 as described herein.

In some implementations, the profile 100 can further have a first surface 110. The first surface 110 may also be referred to herein as a front surface or “inside surface,” indicating that the first surface 110 may generally become the inside of a resulting channel letter once the profile 100 has been cut and folded into a letter shape. The profile 100 (or the rule 102) can generally have a height 112 on the order of a few centimeters (cm) (e.g., one or two cm) to in excess of 20 cm. The height 112 can also describe the height of the first surface 110. The profile 100 may also be many meters long (in the direction of the profile axis 108).

In some implementations, the rule 102 can be formed with a suitable metallic material, such as aluminum, steel, stainless steel, or various other alloys that provide a malleable, yet sturdy construction. The rule 102 may further have a protective coating to prevent corrosion or oxidation and to provide a suitable mounting surface for the rib 120. Such a protective coating can be applied at least to the first surface 110, but can also be applied to an outside surface (not shown). The outside surface is opposite the first surface 110 and may generally become the outside of the resulting channel letter once the profile 100 is cut and folded. In certain implementations, such a protective coating may be an enamel coating.

The profile 100 can further have the rib 120. The rib 120 can be one of several ribs as shown below in the following figures. In some implementations, the rib 120 can be attached, bonded, or otherwise adhered to the rule 102. In some implementations, the rib can be formed of a polymer, elastomer, plastic, fiber-reinforced plastic (FRP), or other suitable synthetic materials.

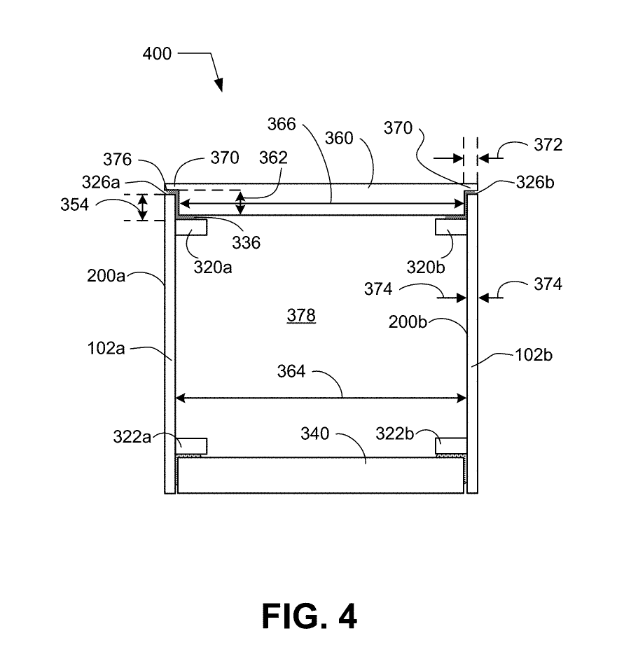

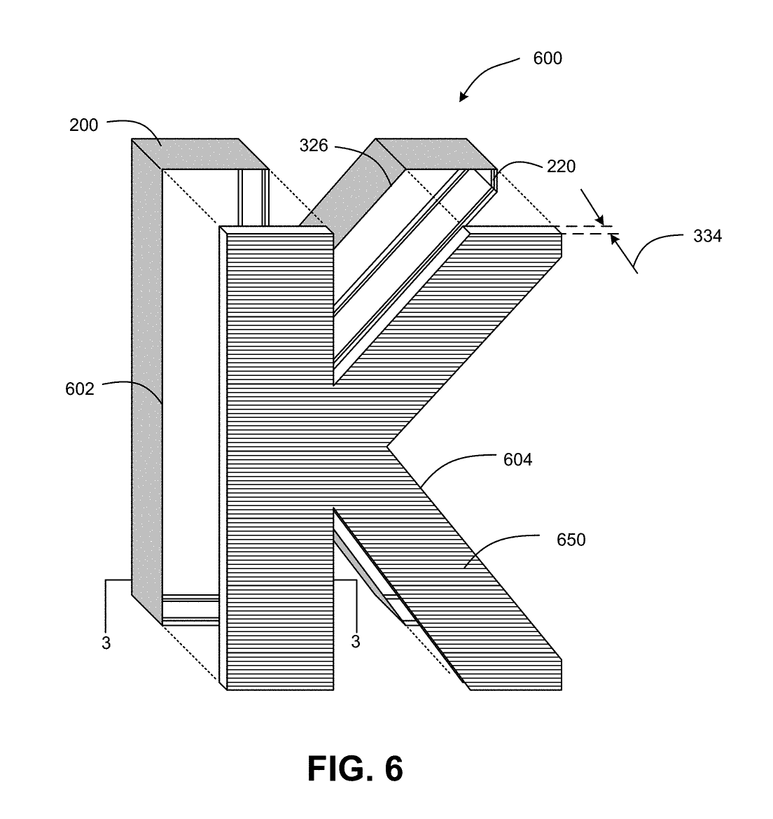

Once the profile 100 is cut and folded (see FIG. 5) the rib 120 can provide a mounting point for a face plate (see FIG. 3 through FIG. 6) to complete the channel letter. The composition or materials of the rib 120 and the face plate are then important for proper bonding as described below.

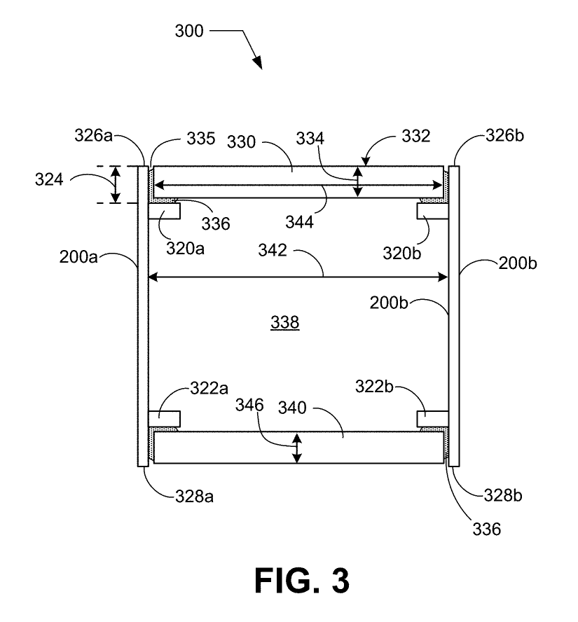

FIG. 2 is a perspective view of another implementation of a profile. As shown, a profile 200 is similar to the profile 100, having the rule 102. The profile 200 can further have a rib 220 and a rib 222 adhered to the first surface 110. In some implementations, the profile 200 can then be similar to the profile 100 with the additional rib 222. Similar to the rib 120 (FIG. 1), the rib 220 can provide a mounting point for a face plate (see FIG. 3). The second rib 222 can further provide a second mounting point for a back plate or bottom plate or other mounting options as described below.

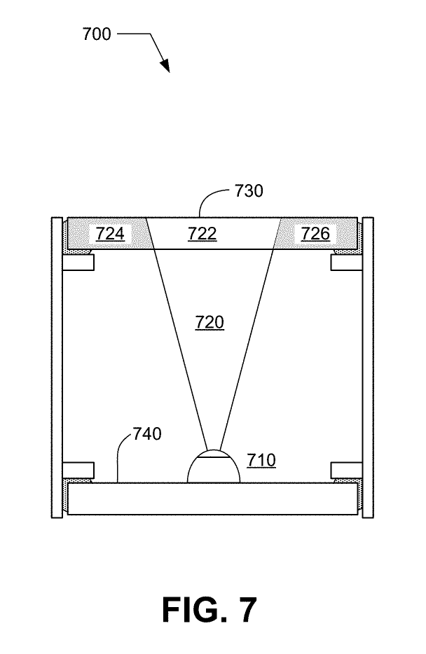

FIG. 3 is a sectional view of a portion of an example channel letter. A portion of the channel letter 300 is shown using the profile 200 of FIG. 2. The section is taken along a line 3-3 of FIG. 6, described below. As shown, a profile 200a and a profile 200b are used in the formation of the channel letter 300. In some implementations, other previously described profiles 100 can be used in a similar manner to form the channel letter 300.

In some implementations, the portion of the channel letter 300 shown can be formed of a single length of the profile 200. Therefore in some implementations, the profile 200a and the profile 200b can be two portions of the same length of bended profile. The profile 200a and the profile 200b may be referred to collectively as the profiles 200.

The profile 200a can have a top rib 320a and a bottom rib 322a. Similarly, the profile 200b can have a top rib 320b and a bottom rib 322b. The top rib 320a and the top rib 320b (collectively referred to as “top ribs 320”) can be similar to, for example, the rib 120, the rib 220, or the other ribs described in connection with the preceding figures. The ribs 320a, 320b and the ribs 322a, 322b are distinguished for purposes of description.

The top ribs 320 can be located a distance 324 from a top edges 326 of the profiles 200. In an implementation, the distance 324 provides sufficient space to receive a face plate 330 such that a top surface 332 of the face plate 330 is flush with the top edge 326 of the profile 200a when the channel letter 300 is completed. Accordingly, the face plate 330 can have a face plate thickness 334 that is slightly smaller than the distance 324, such that there is a gap 335 between the adjacent portions of the rib 320, the rule 102, and the face plate 330.

In some implementations, the profile 200a and the profile 200b can be separated by a distance 342. The distance 342 can be slightly larger than a face plate width 344. Accordingly, the profiles 200 may be spaced apart such that the channel letter 300 can receive the face plate 330 with a clearance fit. The gap 335 may therefore be formed or otherwise configured to receive an adhesive 336. In some implementations, the adhesive 336 used for bonding the face plate 330 to the rib 320 and the rule 102 may be an adhesive specifically designed for bonding plastics or other polymers. The adhesive 336 may further create a permanent bond or weld between the face plate 330 and the ribs 320.

In some implementations, the face plate 330 can be formed of a certain plastic, acrylic, or other polymer and may form the outline of a particular letter (e.g., a “k”) or other possible form (see FIG. 5, FIG. 6). In some implementations, the face plate 330 can have a translucent or transparent structure formed from certain acrylics or other plastics, thereby allowing the light to pass through the face plate 330.

In certain implementations, the top surface 332 of the face plate 330 is flush with the top edges 326a, 326b of the profile 200a and the profile 200b in the completed channel letter 300. This may provide certain aesthetic advantages because there is no further bending or forming required of the face plate 330 to flange or wrap it over the top edges 326. The face plate 330 may be cast, molded, or formed to the specific interior dimensions (e.g., the face plate width 344 is slightly smaller than the distance 342) of the completed channel letter 300 and secured in place with the adhesive 336. In some implementations, the adhesive 336 may form a water tight seal between the face plate 330 and the profile 200, thereby protecting the contents of the channel letter 300, such as one or more lights or certain electronics. Accordingly, the channel letter 300 may further have a central space 338 sized to accommodate one or more lights that can project through the face plate 330.

In certain implementations, the channel letter 300 may further have a bottom plate 340. The bottom plate 340 may be similar to the face plate 330 and be formed to fit between the profiles 200 in a similar manner to the face plate 330. The bottom plate can further have similar dimensions as the face plate 330. For example, the bottom plate 340 can have a bottom plate thickness 346. The bottom plate thickness 346 can be similar to the face plate thickness 334. Accordingly, the bottom plate 340 can be fit between and be secured to a rib 322a and a rib 322b near bottom edges 328a, 328b (collectively referred to as bottom edges 328) of the profiles 200. Thus the bottom plate 340 may be secured in place between the profiles 200 by the adhesive 336, similar to that described above. The bottom plate 340 can further be secured to a wall or other mounting surface in certain implementations. The bottom plate 340 can further be flush with the bottom edges 328 in the channel letter 300 when bonded in place. In another implementation, the bottom plate 340 can be formed of a translucent or transparent material, such as for example, acrylic. In still another implementation, the bottom plate 340 can be a portion of a larger structure formed to support a series of channel letters 300.

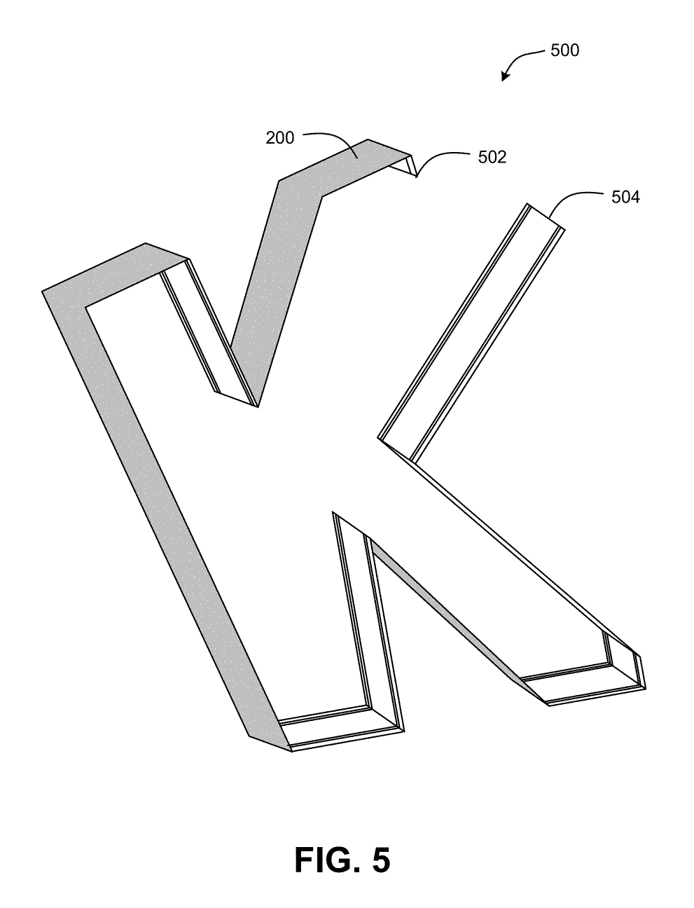

FIG. 4 is a sectional view of a portion of another example channel letter. A portion of a channel letter 400 is shown, having the profiles 200, similar to the channel letter 300 described above. The portion of the channel letter 400 shown can be another implementation taken along the line 3-3 of FIG. 6. The profiles 200 may be formed from a single section of profile 200 that is bent or folded back on itself to form the channel letter 400.

In certain implementations, the channel letter 400 can have the ribs 320 and the ribs 322 that are spaced in a similar fashion as in the channel letter 300. The ribs 320 can be separated from the top edge 326a and a top edge 326b by a distance 354. The distance 354 may be similar to the distance 324 (FIG. 3). The profile 200a (e.g., the rule 102a and the rib 320a) and the profile 200b (e.g., the rule 102b and the rib 320b) can be spaced apart by a distance 364.

The channel letter 400 can also have a face plate 360. The face plate 360 can further have a face plate width 366 that is slightly smaller than the distance 364 to receive the face plate 360 in a clearance fit, similar to FIG. 3. The face plate 360 can also have a face plate thickness 362 slightly smaller than the distance 354.

The face plate 360 can also have a lip 370. The lip 370 can be formed about a perimeter of the face plate 360. In some implementations, the lip 370 can be sized to overlap the top edges 326 of the profiles 200 such that it covers the top edges 326 of the profiles 200. The lip 370 can have a lip depth indicated by the arrows 372 (referred to herein after as lip depth 372). The lip depth 372 can be slightly larger than a profile thickness, indicated by the arrows 374 (hereinafter profile thickness 374). The profiles 200 can thus be spaced apart to receive the face plate 360 with a clearance fit. The clearance fit may leave a small gap 376 into which the adhesive 336 may be added. The adhesive 336 may be added prior to installing the face plate 360 to the folded profiles 200.

In some implementations, the lip 370 in conjunction with the adhesive 336 and the top edge 326 may further serve to create a sealed space 378 beneath the face plate 360. Similar to the face plate 330 (shown in FIG. 3), the face plate 360 can be translucent or transparent so as to allow light to penetrate the face plate 360.

In some other implementations, the channel letter 400 can further have the bottom plate 340 as shown in FIG. 3. In another implementation, the bottom plate 340 can be formed similar to the face plate 360.

FIG. 5 is a perspective view of a channel letter formed using a profile. An incomplete channel letter 500 (i.e., an almost completed channel letter) resembles an incomplete letter “K,” open at the top. The letter “K,” for example, can be made from the profile 200 (FIG. 2). The incomplete channel letter 500 can also be formed from the other profiles or other types of profiles. The use of the letter “K” is merely for an example, and should not be considered limiting. Any letter, number, symbol, or form can be bent or folded. The incomplete channel letter 500 is open at the top, where a first end 502 can be secured to a second end 504 to complete the incomplete channel letter 500. The first end 502 can be secured to the second end 504 by the use of an adhesive similar to the adhesive 336. Such adhesives 336 can be specially formulated for use with composites, enamel coatings, or other synthetic materials or such as plastic, acrylic, or other polymers. Due to the metal construction of the rule 102, metal welding the first end 502 to the second end 504 may be a further option to close the top of the letter “K.”

FIG. 6 is a front perspective view of the completed channel letter 600 of FIG. 5 fitted with a face plate 650. In an implementation, the first end 502 and the second end 504 are secured together to form a channel letter 600. The channel letter 600 can then be fitted with a face plate 650. The face plate 650 can be similar to the face plate 330 or the face plate 360. The channel letter 600 has channel perimeter 602 described by the top edge 326 of the profile 200 used to generate the channel letter 600. The face plate 650 can have a face perimeter 604 that can be the same or slightly smaller than the channel perimeter 602. The face plate 650 can then be inserted into the channel letter 600 and contained within the channel perimeter 602 in a clearance fit.

The face plate 650 can have the face plate thickness 334 (FIG. 3) that is sized to fit between the top rib 220 and the top edge 326 (FIG. 3). The top rib 220 can also be similar to the top rib 320a or the top rib 320b of FIG. 3. The face plate 650 can be formed to fit within the channel letter 600 and secured in place using the adhesive 336, as described above. In some implementations, the face plate 650 can fit flush with the top edge 326. In some other implementations, the face plate 650 can be formed with the lip 370 as in FIG. 4 to provide a finished look, covering the top edges 326.

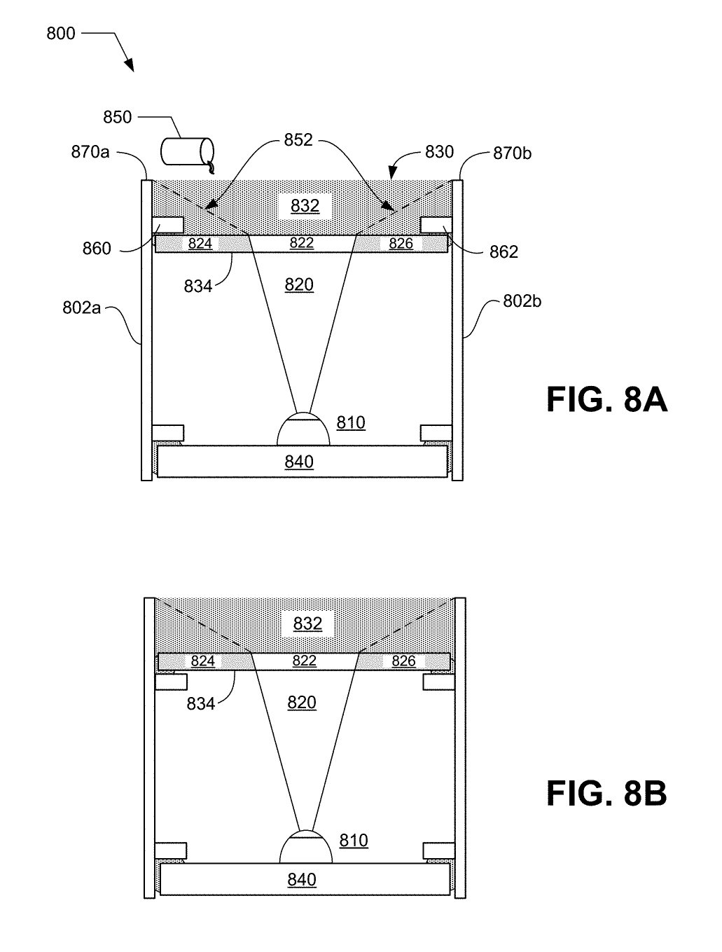

FIG. 7 is a sectional view of a portion of another example channel letter 700 substantially similar to the channel letter shown in FIG. 3. FIG. 7 is shown to illustrate some issues that might arise with this implementation of the channel letter.

In FIG. 7, a light emitting diode (LED) 710 is disposed on the bottom plate 740. Although only one LED is shown, multiple LEDs may be used. The LED 710 shines the light 720 onto the face plate 730 to illuminate the channel letter 700. However, it can be seen that the light 720 from the LED 710 illuminates only a portion 722 of the face plate 730 and leaves dark spots 724, 726 on the face plate 730, which is undesirable for channel letters. As stated above, the face plate 730 can be formed of a certain plastic, acrylic, or other polymer material.

To address the above-recited issues with the channel letter 700 as configured in FIG. 7, some modifications can be made to the implementation of the channel letter 700 of FIG. 7.

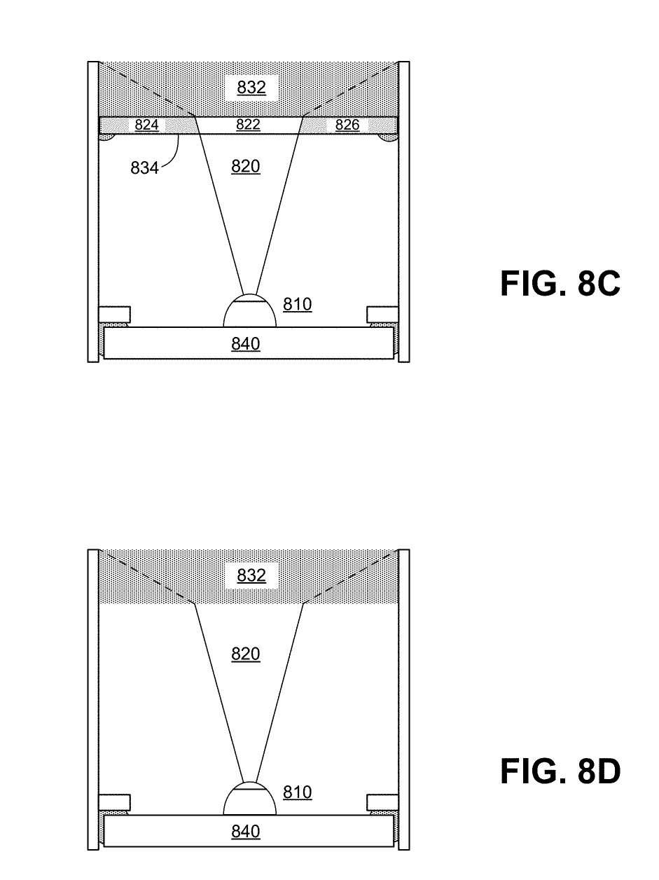

FIG. 8A is a sectional view of a portion of a channel letter 800 in accordance with another implementation of the present disclosure.

In the illustrated implementation of FIG. 8A, the face plate 834 formed of a certain plastic, acrylic, or other polymer material is moved to a position below the ribs 860, 862, and the moved face plate 834 is attached to the bottom of the ribs 860, 862 using an adhesive. This leaves a space above the face plate 834 and the ribs 860, 862 up to the top 870a, 870b of the profiles 802a, 802b. The purpose of this implementation is to put material in the space that would widen the light beam 820.

In FIG. 8A, the LED 810 is disposed on the bottom plate 840 and the light 820 is shined onto the face plate 834. As before, it can be seen that the light 820 from the LED 810 illuminates only a portion 822 of the face plate 834 and leaves dark spots 824, 826 on the face plate 834. However, unlike the implementation shown in FIG. 7, the space above the face plate 834 is filled with resin material 832, which is highly viscous substance. The use of the resin material enables the gel-like liquid to be poured (see 850) into the space. The liquid resin is then made to dry and harden (using various methods such as leaving it open to air) to form a transparent plate that widens 852 the light beam 820 coming from the LED 810 and shining on the front surface 830. In one implementation, color can be mixed into the transparent plate to show color letters.

Various alternative implementations to the illustrated implementation of FIG. 8A can be formed. For example, in another implementation, a face plate can be attached to the top of the ribs prior to pouring the resin material 832 (see FIG. 8B). In yet another implementation, the face plate can be attached to the inner surface of the profiles (e.g., inner surface of the profiles 802a, 802b) in lieu of the ribs after the shaping of the channel letter is completed (see FIG. 8C). In yet another implementation, the face plate is put in place temporarily and removed after the resin material is poured in and hardened (see FIG. 8D).

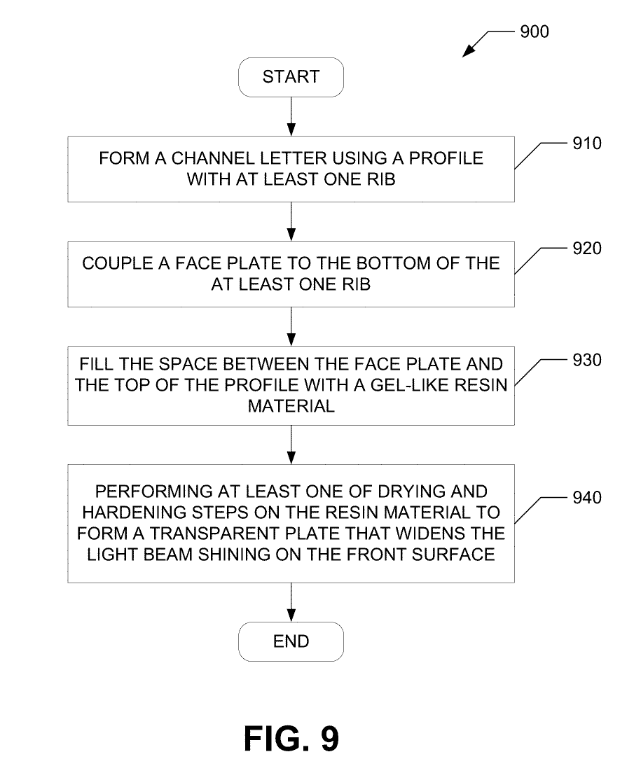

FIG. 9 is a functional flow diagram illustrating a method 900 for substantially reducing dark spots on the front surface of the channel letter in accordance with one implementation of the present disclosure. Initially, a profile with at least one rib is used to form a channel letter, at block 910. A face plate is then coupled to a position below the at least one rib, at block 920. As stated before, the face plate is formed of a certain plastic, acrylic, or other polymer material. In one implementation, the face plate is coupled to the at least one rib using an adhesive. This leaves a space above the face plate 834 and the at least one rib 860, 862 up to the top 870a, 870b of the profiles 802a, 802b. The space is then filled with a gel-like resin material, at block 930. In one implementation, the gel-like resin material is semi-liquid such that it can be poured into the space. In an alternative, the resin material may be formed with pre-hardened material so that the drying and/or hardening step can be removed. Finally, at block 940, at least one of drying and hardening steps is performed on the resin material to form a transparent plate that widens 852 the light beam 820 coming from the LED 810 and shining on the front surface 830. In one implementation, color can be mixed into the transparent plate to show color letters.

The above descriptions of the disclosed implementations are provided to enable any person skilled in the art to make or use the disclosure. Various modifications to these implementations will be readily apparent to those skilled in the art, and the generic principles described herein can be applied to other implementations without departing from the spirit or scope of the disclosure. For example, although FIGS. 8A to 8D show only four different implementations of forming a channel letter using resin material, other additional implementations for using the resin material can be similarly formed. Thus, it will be understood that the description and drawings presented herein represent implementations of the disclosure and are therefore representative of the subject matter which is broadly contemplated by the present disclosure. It will be further understood that the scope of the present disclosure fully encompasses other implementations that may become obvious to those skilled in the art and that the scope of the present disclosure is accordingly limited by nothing other than the appended claims.

Accordingly, the foregoing implementations are merely presented as examples and are not to be construed as limiting the present disclosure. The present teachings can be readily applied to other types of apparatus and/or devices. The description of the present disclosure is intended to be illustrative, and not to limit the scope of the claims. Many alternatives, modifications, and variations will be apparent to those skilled in the art.

What is claimed is:

1. A method for substantially reducing dark spots on a front surface of a channel letter, the method comprising:
forming a channel letter using a profile with at least one rib, the profile having a top and a bottom;
coupling a face plate to the at least one rib; and
filling a space between the face plate and the top of the profile with a resin material.

2. The method of claim 1, wherein the face plate is coupled to a position below the at least one rib.

3. The method of claim 1, wherein the resin material is formed with gel-like material so that the resin material can be poured into the space.

4. The method of claim 3, further comprising
performing at least one of drying and hardening steps on the gel-like resin material.

5. The method of claim 1, wherein the resin material is formed with pre-hardened material.

6. A channel letter formed using a profile including at least one rib, the channel letter comprising:
a face plate coupled to a first rib of the at least one rib; and
a layer of resin material disposed between the face plate and a top of the profile.

7. The channel letter of claim 6, wherein the face plate is formed with one of plastic or acrylic.

8. The channel letter of claim 6, wherein the face plate is coupled to a position below the first rib.

9. The channel letter of claim 6, wherein the face plate is coupled to a position above the first rib.

10. The channel letter of claim 6, wherein the layer of resin material is formed with gel-like material.

11. The channel letter of claim 6, wherein the layer of resin material is formed with pre-hardened material.

12. The channel letter of claim 6, further comprising
a bottom plate coupled to a second rib of the at least one rib, the bottom plate configured to accept light emitting diodes used to illuminate the layer of resin material.

13. The channel letter of claim 6, wherein the layer of resin material includes coloring material.
